(19) United States
(12) Patent Application Publication
(10) Pub. No.: US 2007/0001156 A1
(43) Pub. Date: Jan. 4, 2007

(54) Degradable or reversible fire-blocking gel

(76) Inventor: William Toreki III, Gainesville, FL (US)

Correspondence Address: WILLIAM TOREKI, 4632 SW 47 WAY, GAINESVILLE, FL, 32608, US

(21) Appl. No.: 11/194,830

(22) Filed: Aug. 1, 2005

Related U.S. Application Data
(60) Provisional application No. 60/598,453, filed on Aug. 4, 2004.

(51) Int. Cl. C09K 21/00

(52) U.S. Cl. 252/601

(57) ABSTRACT

This invention relates to a method of preventing a combustible object from burning and to a method of extinguishing a burning object by applying a degradable or reversible, insulating, superabsorbent polymer material to the combustible object. The invention also relates to articles of manufacture useful for preventing a combustible object from burning, and for insulating a person or object from increased temperature.

This application claims benefit of priority to U.S. provisional application Ser. No. 60/598,453 filed Aug. 4, 2004.

### FIELD OF THE INVENTION

This invention relates to a method of preventing a combustible object from burning and to a method of extinguishing a burning object by applying a degradable or reversible, insulating, superabsorbent polymer material to the combustible object. The invention also relates to articles of manufacture useful for preventing a combustible object from burning, and for insulating a person or object from increased temperature.

### BACKGROUND OF THE INVENTION AND PRIOR ART

Water is often used to extinguish fires or to prevent combustible objects from burning. Water can reduce the temperature of combustible material and exclude oxygen until the material is at too low of a temperature to burn. When a fire is extinguished by spraying water on the fire, only less than about 8% of the water is generally effective in extinguishing the fire, due to loss of water, such as by run-off or evaporation of the water.

Water-absorbing resins or superabsorbent polymers (“SAP”), are polymeric materials that are insoluble in water but can absorb at least ten times, preferably at least 20 times their weight in tap water, and traditionally have not been used previously in fighting fires, but have been used widely in sanitary goods, hygienic goods, wiping cloths, water retaining agents, dehydrating agents, sludge coagulants, disposable litter mats for pets, condensation preventing agents, and release control agents for various chemicals.

The present invention is directed to a method of using a degradable or reversible SAP to smother fires or prevent combustible objects from burning by coating combustible objects with a composition of a superabsorbent polymer and water, preferably a gel formed from SAP and water. Commercially available SAP gel fire-blocking products are available; however, since the SAP gel of this application is degradable or reversible, it is much easier to wash-off or remove from the treated structure when no longer needed.

It is known that the application of a layer of aqueous-based superabsorbent polymer (SAP) gel can provide fire protection to buildings, trees, utility poles, and other structures. U.S. Pat. No. 5,849,210 (to Pascente) describes this method in detail. The concepts and descriptions related to that invention are herein incorporated by reference.

An improvement to the method of Pascente is found in U.S. Pat. Nos. 6,245,252 and 5,989,446 (to Hicks), wherein the SAP is used in the form of a water-in-oil emulsion in order to provide improved stability, delivery, and use of the fire retardant composition. There are several commercially available products based on this concept. Barricade International sells “Barricade Fire-Blocking Gel”. Additional information can be found at Barricade International's website (http://www.barricadegel.com). Other commercial products include “E112 Fire-Blocking Gel”, sold by Nochar, Inc., “Cold Shield Thermal Shield Gel”, sold by Dytec Services, and “Thermo-Gel Fire-Blocking Gel”, sold by Thermo-Cool.

These products work well, and are responsible for the saving of millions of dollars worth of property in the United States every year. The gels are relatively inexpensive and easy to apply; however, the sticky and slippery gel may persist for several weeks after the threat of fire has passed, and must be washed off to completely remove it. In some cases the use of a high-pressure power washer is needed. This limitation is well known, and is discussed in many of the news articles describing this product (see for instance: “Ready for Fire Season” by Kathy Sena, The Los Angeles Times Aug. 31, 2003, pages K-1 and K4.

Sheu, in U.S. Pat. No. 6,290,887, describes an invention, which generally is directed to compositions, products, and methods that utilize superabsorbent polymers for flame-retarding. A preferred method includes improving flame-retarding characteristics in products by adding SAPs to the product. Prior to the step of adding the SAPs, the product exhibits a first limiting oxygen index and after the step of adding the SAPs, the product exhibits a second limiting oxygen index, with the second limiting oxygen index being higher than the first limiting oxygen index. Preferably, the SAPs can be pre-loaded with moisture, thereby potentially further increasing the flame-retarding characteristics of the product. In a preferred embodiment, the product is configured as a cable, with the outer jacket of the cable incorporating the SAPs. The SAPs utilized are similar to the products and methods described above, and are not reversible or degradable, and therefore may be difficult to remove when desired.

In US Patent application 20030038272, Figiel describes a composition, which retards the spread of fire, protects assets at risk from fire damage, and emits a material which aids in extinguishing the fire. The composition may be either in the form of a gel or foam, and may be used to protect any sort of object, such as personal property, real property, or even humans, from fire. The gel form of the composition contains urea or a urea derivative that retains water and releases CO₂ upon heating. In addition, a rheology modifier containing carboxyl groups is also employed. The foam form of the composition contains the urea or urea derivative and the rheology modifier, along with a foam generator such as sodium bicarbonate and citric acid. A method of retarding fire comprises the coating of an item with the fire retardant such that the retardant protects the item from the fire and aids in extinguishing the fire by releasing carbon dioxide. Again, the SAP gels of that invention are not reversible or degradable, and thus may be difficult to remove from treated surfaces.

It would be extremely useful to have a degradable fire-blocking gel which is easy to remove, or which has a limited lifetime after application. A reversible or degradable SAP material is capable of being easily washed-off after a predetermined useful lifetime is described in this application. The present application describes this improved material.

### SUMMARY OF THE INVENTION

The present invention is directed to a method of preventing a combustible object from burning, or reducing the extent of burning of a combustible object, by contacting the combustible object, before or during burning, with an aqueous composition comprising a reversible or degradable superabsorbent polymer and water. Water can be added to hydrate the reversible or degradable superabsorbent polymer after contacting the combustible object with neat reversible or degradable superabsorbent polymer (unhydrated reversible or degradable SAP), or more preferably, the reversible or degradable SAP is premixed with water in a reversible or degradable SAP concentration of about 0.01% reversible or degradable SAP to about 25% by weight reversible or degradable SAP, and preferably about 0.1% reversible or degradable SAP to about 2.5% reversible or degradable SAP. When applied wet, particularly to surfaces having a vertical component, e.g., vertical walls, the surface can be pre-coated with an adhesive, e.g., a water soluble adhesive, such as an aqueous solution of guar gum in an amount sufficient to adhere the reversible or degradable SAP in position on the surface of the object to be protected prior to hydration of the reversible or degradable SAP with water.

Additionally, the present invention is directed to a method of preventing a combustible object from burning by spraying an aqueous reversible or degradable SAP composition onto a combustible object, prior to combustion of said combustible object, e.g., from a hand-held fire extinguisher, or by admixing powdered or granular reversible or degradable SAP with a flowing stream of water. Further, the present invention is directed to a method of extinguishing at least a portion of a fire by spraying a burning object with the aqueous reversible or degradable SAP composition in an amount sufficient to continuously or discontinuously coat the burning object with the aqueous reversible or degradable SAP composition to sufficiently cool the burning object, or in an amount sufficient to reduce the quantity of oxygen from reaching the surface of the burning object to a degree such that the flame is extinguished. Additionally, the present invention is directed to flame retardant articles that can be manufactured to include dry reversible or degradable SAP and can be wetted on demand to form a flame shield or flame retardant blanket or garment to protect fire fighters and others in a burning building or similar situation.

Therefore, an object of the invention is to overcome one or more of the problems described above. Furthermore, since the SAP is degradable or reversible, it can easily be removed or washed-off of the substrate when desired or no longer needed.

According to the invention, a method of preventing a combustible object from burning includes the steps of providing a firefighting or fire-preventive composition comprising a mixture of water and a reversible or degradable superabsorbent polymer (“SAP”), preferably in the form of a gel, and applying the firefighting gel to the combustible object prior to or during pyrolysis thereof.

The invention also is directed to an article of manufacture including a continuous or discontinuous layer of reversible or degradable SAP that is useful for preventing a combustible object from burning.

Other objects and advantages of the invention will be apparent to those skilled in the art from the following detailed description, taken in conjunction with the appended claims.

In the context of this application, “gel” means a form of material between the liquid and solid state that consists of physically, chemically, or associatively crosslinked networks of long polymer molecules with liquid molecules trapped within the network—a three-dimensional network swollen by a solvent. If the solvent is water, the gel is termed a “hydrogel”. The terms “reversible” and “degradable” in the context of this invention refer to gel, hydrogel, or superabsorbent polymer materials that can be converted from their crosslinked, swellable, or gel state into a non-crosslinked liquid, fluid, or soluble form that is more easily removed from a substrate by rinsing or washing with water. “Reversable” generally refers to dissolution of a physically crosslinked gel; whereas, “degradable” generally refers to dissolution of a chemically crosslinked gel, as described in the following paragraphs. “Gelatinous” means having a semi-solid, gel-like structure or form, and is not intended to imply that the material contains gelatin (collagen) molecules.

### DETAILED DESCRIPTION OF THE INVENTION

Gels may be classified as either chemical gels or physical gels. Chenical gels are formed by chemical covalent bonds, resulting in a products called covalently crosslinked gels, and are not reversible unless chemical bonds are broken. Physical gels are formed by secondary physical forces, such as hydrogen bonding, hydrophobic, or ionic interactions, and are reversible without the need for breaking of chemical bonds. The use of reversible gelling compounds is known in the art. Any of these crosslinking mechanisms may be used to provide a degradable or reversible SAP fire-blocking gel. The three-dimensional covalently crosslinked networks swell greatly in water; however, since the individual polymer chains are connected by crosslinks, dissolution does not occur. If the crosslinks are removed or broken to a sufficient extent, the remaining linear or branched polymer chains once again become soluble, and dissolve in the presence of excess water. Thus, breaking of the crosslinked SAP allows it to be easily washed away. If the crosslinking is reversible, simple dilution may cause the hydrogel to eventually dissolve spontaneously, thus allowing it to be easily washed away. In this case, additional degrading compounds or stimuli may not be needed; however, they can still be used to accelerate the dissolution process, as described below.

A pH-sensitive gel can be formed, for example, by mixing dilute solutions of polyvinyl alcohol (PVA), and borax. This is an example of a reversible gel crosslinked by hydrogen-bonds, which is stable, but can be dissolved by dilution into a free-flowing solution. This dissolution is accelerated upon exposure to acidic conditions, due to disruption of the stabilizing hydrogen bonds. Thus, a PVA-borax SAP gel can be applied to a structure to protect if from fire, and then be removed easily by spraying with a dilute mild acid solution, such as citric acid, phosphate buffer, or ammonium salts. This, and other, reversible SAP hydrogels sensitive to pH can be solubilized by direct application of acid (or base), or the pH change can be a result of environmental factors. In many parts of the world, rainwater is sufficiently acidic to quickly dissolve such a composition. It is expected that this composition would also absorb carbon dioxide from the atmosphere, which eventually will result in spontaneous degradation of the gel. It should be noted that commonly used SAP gels based on partially neutralized salts of poly(acrylic acid) or derivatives are know to be pH-sensitive; however, only to the extent that changes in pH cause a change in the degree of hydration or swelling of the SAP gel, and the chemical bonds forming the backbone and crosslinks in such polymers are stable to changes in pH. Thus, conventional hydrogels such as those based on acrylic acid salts are not easily converted by pH changes to soluble forms capable of being easily removed from a surface. In fact neutralization by acid actually makes the gels contract making them harder to remove.

A similar reversible gelling mechanism, in response to pH change in solution is exhibited by chitosan, a naturally-occurring polymer with a sol-to-gel transition at a pH of about 7.0, when pH changes from slightly acidic to neutral.

Su, in U.S. Pat. No. 4,501,834 discloses soluble reversible hydrogel polymers which are formed as complexes between a polyanion and a polycation. Since there are no physical crosslinks, or covalent bonds between the two oppositely charged polymers, simply diluting them with water results in their eventual dissolution. In addition, the hydrogels are seen to be stable at elevated temperatures. In the case of two oppositely-charged polymers, either one or both is usually acid or base sensitive, and thus pH changes can be utilized in order to disrupt gel formation and cause dissolution. Reaction of this polyelectrolyte complex hydrogel with acid or base would cause the polyvalent anions or cations to become partially or wholly neutralized, resulting in loss of ionic crosslinking. This would cause the gel to become a soluble liquid. Acid or base can be sprayed directly onto the gel, or can be incorporated into the formulation before application. This can be accomplished by microencapsulation of the acid or base, for example. Addition of monovalent salts, such as NaCl should also cause this gel to become unstable. Thus, the materials described by Su would potentially have use as reversible or degradable fire protection gels if coupled with an appropriately designed degradation trigger.

Reversible hydrogels can also be formulated from a charged polymer and a small multivalent anion. The reaction between poly(sodium alginate) and divalent calcium ion is an example. Adjustment of ionic strength or pH can be used to modify the ionic forces which cause this gel to form, and as such can be used to control the firmness and solubility of the gel. Another example of this type of gel would be that formed from a polycation such as: [poly(diallyldimethylammonium chloride), or chitosan]; and [sulfate, carbonate, hexamethylene-1,6-di-(aminocarboxysulfonate), phosphate, or other multivalent anions]. Reaction of this hydrogel with acid causes the multivalent anions to become partially protonated, resulting in loss of their multivalent charge and crosslinking ability. This causes the gel to become a soluble liquid. Acid can be sprayed directly onto the gel, or can be incorporated into the formulation before application. This can be accomplished by microencapsulation of the acid, for example. Addition of monovalent salts, such as NaCl would also cause this gel to become unstable. It is expected that carbonate ion crosslinks would be reactive with atmospheric carbon dioxide, causing the gel to spontaneously decompose after a predetermined time based on composition. Another example is to use a linear or branched, but not chemically crosslinked, partially neutralized salt of poly(acrylic acid) in combination with a difunctional ammonium compound such as 1,3-diaminopropane dihydrochloride salt. This will form a reversible SAP hydrogel which is sensitive to base.

Gutowska, in U.S. Pat. No. 6,660,247 describes various reversible hydrogels for medical applications. The described materials are mainly temperature-sensitive; however, the use of temperature as a solubility mechanism is not expected to be of practical use in fire-protection applications. Gelatin is an example of a temperature-sensitive SAP hydrogel.

In the case of covalently crosslinked hydrogels, the gels are generally not reversible, and some chemical bonds must be broken in order to obtain solubility. Degradable, covalently-bonded, superabsorbent hydrogels can be formulated in a variety of ways. For instance, additives can be mixed with the gel at the time of application that cause the gel to spontaneously degrade after a specified period of time. Another approach is to utilize a gel system that is sensitive to certain degrading compounds, which are applied later (by spraying, for instance). Microencapsulated degrading compounds may be used in either approach, and can be added to the gel during manufacture, or at the time of application. Various additives and degrading stimuli or compounds may be used. These include, but are not limited to: enzymes, microorganisms, oxidizing/reducing agents, and chemical compounds. Another approach is to utilize environmental stimuli such as sunlight, or oxidation, or action of environmental microorganisms.

The commercially available fire-blocking gels described above are all based on covalently crosslinked non-degradable SAP hydrogels. The term “non-degradable” is relative, and for the purposes of this invention refers to a reasonable time frame consistent with the needs of fire protection (i.e., 24-72 hours). Many commercially available SAP hydrogels can persist relatively unchanged in an outdoor environment for at least several months. For the purposes of this application, the term “degradable” refers to materials that become substantially solubilized in water within approximately 24-72 hours after their application, or within 24-72 hours after application of a degradation stimulus. In the case of the commercially available SAP fire-blockers, the gel particles may persist for months, and in many cases must be washed off of treated surfaces using a high-pressure power washer. This does not destroy the gel particles; however, and they still may pose hazards such as slippery ground, clogging of soil and drains, as well as the potential to cause unsightly stains, or have adverse effects on plant and animal life. The use of a reversible gel, or a degradable gel, which converts into a true water-soluble liquid, alleviates these problems.

Enzymatic degradation of covalently crosslinked SAP hydrogels is a desirable approach. In general, enzymes function in a true catalytic, rather than stoichiometric manner, and thus have a high turnover capacity. This means that only a very low enzyme concentration is required, and thus this type of process can be quite economical. Highly absorbent SAPs are generally only lightly crosslinked, meaning that cleavage of just a few bonds can result in solubility due to rapid loss of gel structure. Cleavage of the main polymer backbone, or cleavage of the crosslinking bonds both have the same effect, and cause a gel to solution transition.

For instance, a class of enzymes known as proteases cleaves the amide linkages in proteins (which are actually polymers). A common commercially available SAP formulation is a partially-neutralized, polyacrylate SAP crosslinked with difunctional methylene-N,N′-bis-acrylamide. The crosslink bonds in this material are amide moieties, which are similar in nature to those found in proteins. Thus, proteolytic enzymes such as pepsin, trypsin, or others, will rapidly degrade this SAP hydrogel into a water-soluble polymer. Gelatin is a protein (collagen). It is known in the art that thermally stable SAP hydrogels can be made using gelatin crosslinked with glutaraldehyde. Collagenase enzyme will degrade the gelatin SAP and cause a gel to solution transition.

Starch-based SAP hydrogels are also commonly known in the art. In particular, enzymes such as amylase, which is present in saliva, cleave starch molecules. Thus reaction of a starch-based SAP with amylase will result in degradation of the three-dimensional crosslinked structure. Similarly, other enzymes are capable of degrading other polysaccharide based SAP hydrogels. For instance, hydrogel materials based on cellulose derivatives such as methyl cellulose, hydroxyethyl cellulose, or other cellulose derivatives will be degraded upon exposure to celluase enzymes. Enzymatic degradation of SAP hydrogels based on polysaccharides including, but not limited to, cellulose, starch, dextran, alginate, guar gum, xanthan gum, and derivatives thereof, are an aspect of this invention.

Enzymes can be added directly to the SAP materials at the time of application if the parameters (concentration, temperature, pH, etc) are carefully chosen in order to prevent premature degradation of the SAP hydrogel. The activity rate of most enzymes is sensitive to pH, so it is also possible to add a volatile pH-affecting material to the mixture. This is formulated so that the pH of the SAP hydrogel enters the range of optimum efficiency after a predetermined time (generally 24 to 48 hours), as the volatile pH-adjusting material (such as ammonia) evaporates. Of course, temperature (such as from a fire) can alter both the rate of pH change, and the rate of enzymatic activity; therefore, these factors must be accounted for.

It is also possible to spray an enzyme solution directly onto the SAP hydrogel after the threat of fire is passed, and the material is no longer needed. The enzyme solution may be applied alone, or in conjunction with other agents.

It is also possible to microencapsulate the enzyme (or other chemical or degradation stimulating agent), as microencapsulation of enzymes is known in the art. The microencapsulated enzyme is then added to the SAP premix. In U.S. Pat. Nos. 6,245,252 and 5,989,446 (to Hicks), the SAP is used in the form of a water-in-oil emulsion in order to provide improved stability. Basically, the SAP is in particulate form, with only a small amount of water present in the particles. These concentrated SAP solid solutions are dispersed into a continuous oil phase to form an emulsion. This emulsion is stable, and can be stored for several years. When it is needed, the emulsion is diluted with a large amount of water, and the dispersed SAP particles then quickly swell. It is possible to co-disperse encapsulated enzyme into the same emulsion, using a water-soluble, but oil insoluble, matrix for the microencapsulated enzyme. The enzyme is thus kept separated from the SAP until the emulsion is diluted with water, and an additional mixing step is not required.

It should be noted that methods described herein for inducing the degradation of covalently crosslinked SAP hydrogels could also be used in conjunction with reversible hydrogels, which are not crosslinked through covalent bonds. These methods may be utilized alone, or in conjunction with other degradation mechanisms discussed herein for reversible SAP hydrogels.

Chemical based degradation methods may also be used for the solubilization of SAP hydrogels. This will generally rely on the addition of chemical agents. Preferably, these agents pose little health or environmental hazards. Dilute and/or weak acids and bases may be used (such as ammonium or carboxylic acid salts, or carbonate salts), or dilute solutions of oxidizing agents such as hypochlorite or peroxydisulfate may be utilized. Reactive sites, such as easily hydrolyzable ester linkages may be incorporated on the polymer SAP. The degradative reactivity of such sites is enhanced by the addition of the types of chemical agents mentioned. For instance, polyester-based SAP hydrogels will naturally hydrolyze over a period of time when exposed to moist conditions and environmental stimuli such as oxygen, ozone, microbes, or sunlight; however, this may take weeks, months, or longer. Addition of small amounts of acids, bases, or oxidizing agents, will have a synergistic effect and accelerate these hydrolysis reactions in order to achieve a more reasonable SAP lifetime (on the order of days). Chemical additives may be incorporated into the SAP at the time of application, or applied subsequently, after the need for fire-blocking has subsided. Microencapsulated chemical agents can also be added to the degradable or reversible SAPs as described herein, in the section pertaining to the discussion of microencapsulated enzymes. The concepts described herein do not involve haphazard or random use of chemical agents to promote degradation of the SAP. The choice of chemical agent must fit to the particular chemical and stability characteristics designed into the degradable or reversible SAP.

The degradable or reversible SAP hydrogel fire-blocker may additionally comprise a carbon dioxide releasing component, preferably, but not limited to, a urea or a urea derivative comprising a water-soluble agent, that retains water but releases carbon dioxide upon heating. The urea or urea derivative of the composition preferably comprises a urea or a (hydroxyalkyl)urea (“HAU”), which is defined as any urea derivative containing at least one urea group and at least one hydroxyl group. Hydroxyalkylureas release carbon dioxide, a well-known fire retardant, upon heating. Upon heating to approximately 130-170 degrees C., and exposure to fire, the carbon dioxide released by the HAU will act as an aid in extinguishing the fire. Generally, hydroxyalkylureas contain at least one urea group and at least one hydroxyl group. Carbons disposed between the hydroxyl and urea groups may be in linear, branched or substituted configuration. The general structure and description of HAU is set out in U.S. Pat. Nos. 5,840,822 and 5,858,549, and those patents are herein incorporated by reference.

Exemplary types of HAU include, without limitation, mono(hydroxyethyl)urea, N,N-bis(2-hydroxyethyl)urea, tetrakis(2-hydroxyethyl)urea, tris(2-hydroxyethyl)urea, N,N′-bis(2-hydroxyethyl)urea, N,N′-(3-hydroxypropyl)urea, N,N′-bis(4-hydroxybutyl)urea, 2-urea-2-ethyl-1,3-propanediol, saccharide ureas, 4,5-dihydroxyethylene urea, or mixtures thereof. Other useful ureas include ureas having bases of ethylene urea. Most preferably, the urea derivative component comprises N,N-bis(2-hydroxyethyl)urea.

### EXAMPLE 1

This example demonstrates the preparation and use of a pH-sensitive reversible or degradable SAP fire-blocking hydrogel. A solution of approximately 5 wt % of poly(vinyl alcohol) (such as Elvanol, a poly(vinyl alcohol) manufactured by DuPont) in water is prepared. A sufficient amount (approximately 25 mL) of a 2 to 7 wt % aqueous solution of borax is mixed with 100 mL of the poly(vinyl alcohol) solution in order to form a degradable or reversible superabsorbent fire-blocking hydrogel. This gel can be applied to a wooden substrate to prevent burning of the substrate when exposed to fire. When the fire protection is no longer needed or desired, the gel is removed by spraying the gel-coated substrate with an aqueous solution of 5% citric acid, which is allowed to react with the gel for several minutes, then rinsing with water.

### EXAMPLE 2

This example demonstrates the preparation and use of a reversible or degradable SAP fire-blocking hydrogel based on a polymeric protein, which is reversed or degraded via enzymatic hydrolysis. A dilute (˜1-4 wt %) aqueous solution of gelatin (collagen) is prepared, and a sufficient amount of crosslinking agent such as glutaraldehyde or formaldehyde is added to produced a chemically crosslinked water-insoluble degradable or reversible superabsorbent fire-blocking hydrogel. This gel can be applied to a wooden substrate to prevent burning of the substrate when exposed to fire. When the fire protection is no longer needed or desired, the gel is removed by spraying the gel-coated substrate with an aqueous solution of collagenase enzyme, which is allowed to react with the gel for sufficient time to cause chemical degradation and solubilization of the gel, followed by rinsing with water.

### EXAMPLE 3

This example demonstrates the preparation and use of a reversible or degradable SAP fire-blocking hydrogel based on a polysaccharide which forms a hydrogel that is reversible based on ionic interactions. A 1% solution of food grade gellan gum (Kelcogel F) in water is prepared as a viscous, non-gel solution. To 50 mL of this solution is added approximately 1 mL of 5% calcium chloride aqueous solution. The mixture is stirred to produce a water-insoluble degradable or reversible superabsorbent fire-blocking hydrogel. This gel can be applied to a wooden substrate to prevent burning of the substrate when exposed to fire. When the fire protection is no longer needed or desired, the gel is removed by spraying the gel-coated substrate with an aqueous solution of 5 wt % sodium carbonate in water. After several minutes the hydrogel begins to degrade, and can be easily removed by rinsing with water.

Having generally described this invention, including the best mode thereof, those skilled in the art will appreciate that the present invention contemplates the embodiments of this invention as defined in the following claims, and equivalents thereof. However, those skilled in the art will appreciate that the scope of this invention should be measured by the claims appended hereto, and not merely by the specific embodiments exemplified herein. Those skilled in the art will also appreciate that more sophisticated technological advances will likely appear subsequent to the filing of this document with the Patent Office. To the extent that these later developed improvements embody the operative principles at the heart of the present disclosure, those improvements are likewise considered to come within the ambit of the following claims.

What is claimed is:

1. A method of protecting an object from heat or burning, comprising the steps of:
(a) providing a gelatinous firefighting composition comprising water and a degradable or reversible superabsorbent polymer capable of absorbing at least 20 times its own weight of water, and
(b) applying said gelatinous firefighting composition to the surface of said object.

2. The method of claim 1, wherein the firefighting composition comprises about 0.01% to about 25%, by weight, of degradable or reversible superabsorbent polymer and about 75% to about 99.99%, by weight, of water.

3. The method of claim 1, wherein the firefighting composition comprises from about 0.1% to about 2.5%, by weight, of degradable or reversible superabsorbent polymer and from about 97.5% to about 99.9%, by weight, of water.

4. The method of claim 1, wherein the degradable or reversible superabsorbent polymer is selected from the group comprising: a cross-linked polyacrylic acid; a cross-linked, partially neutralized polyacrylic acid; a cross-linked, fully neutralized polyacrylic acid; and mixtures thereof.

5. The method of claim 1, wherein said gelatinous firefighting composition is stored in a pressurized tank before use.

6. The method of claim 1, wherein said gelatinous firefighting composition is prepared by adding degradable or reversible superabsorbent polymer to a flowing stream of water.

7. The method of claim 1, wherein said degradable or reversible superabsorbent polymer is applied to the surface of said object to be protected from heat or burning, and then water is applied to said degradable or reversible superabsorbent polymer on surface of said object, to produce said gelatinous composition.

8. The method of claim 1, wherein the degradable or reversible superabsorbent polymer comprises a pH-sensitive polymeric hydrogel, which becomes water-soluble or non-gelatinous as a result of a spontaneous, induced, or applied pH change.

9. The method of claim 8, wherein the pH-sensitive polymeric hydrogel comprises poly(vinyl alcohol).

10. The method of claim 8, wherein the pH-sensitive polymeric hydrogel comprises poly(vinyl alcohol) crosslinked with borax.

11. The method of claim 8, wherein the pH-sensitive hydrogel comprises chitosan.

12. The method of claim 8, wherein the pH-sensitive hydrogel comprises a polyelectrolyte complex.

13. The method of claim 1, wherein said gelatinous composition is caused to become non-gelatinous via the action of one or more reversing or degrading agents selected from the group consisting of: enzymes, salts, chemical compounds, acids or bases, oxidizing or reducing agents, sunlight, or microbial action.

14. The method of claim 13, wherein said reversing or degrading agents are mixed with gelatinous composition prior to application of the composition to the object to be protected from heat or burning.

15. The method of claim 13, wherein said reversing or degrading agents are in encapsulated or microencapsulated form.

16. The method of claim, 13 wherein said reversing or degrading agents are applied to the gelatinous composition after application of said composition to the object to be protected from heat or burning.

17. A gelatinous firefighting composition comprising a mixture of water and a degradable or reversible superabsorbent polymer capable of absorbing at least 20 times its own weight in water, wherein the degradable or reversible superabsorbent polymer can be more easily removed from a substrate due to the enhanced solubility caused by degradation or reversal of the gel structure of the degradable or reversible superabsorbent polymer to a non-gelatinous state.

18. A method for applying a degradable or reversible superabsorbent polymer gel to a surface to combat fires, said method comprising:
(a) providing a water-in-oil emulsion of degradable or reversible superabsorbent polymer particles capable of absorbing at least 20 times their own weight in water or degradable or reversible superabsorbent polymer hydrogel particles capable of absorbing at least 20 times their own weight in water.
(b) adding said water-in-oil emulsion as a water-absorbent additive to water wherein said water-absorbent additive is present in sufficient quantity such that after absorption of water said water-absorbent additive holds more than about 50% by weight of the total water; and
(c) directing said water-additive mixture onto said surface.

19. The method of claim 23, further comprising the step of educting the additive into the water through standard firefighting eduction equipment.

20. The method of claim 23, further comprising the step of batch-adding the additive to the water prior to use of the water in firefighting.

21. The gelatinous firefighting composition of claim 1 comprising a degradable or reversible superabsorbent polymer which retains water and a material that produces carbon dioxide upon exposure to heat, wherein the material which produces carbon dioxide comprises urea, urea derivatives or mixtures thereof.

22. The fire retardant composition of claim 21, wherein the material which produces carbon dioxide comprises (hydroxyalkyl)urea, mono(hydroxyethyl)urea, N,N-bis(2-hydroxyethyl)urea, tetrakis(2-hydroxyethyl)urea, tris(2-hydroxyethyl)urea, N,N′-bis(2-hydroxyethyl)urea, N,N′-(3-hydroxypropyl)urea, N,N′-bis(4-hydroxybutyl)urea, 2-urea-2-ethyl-1,3-propanediol, saccharide ureas, 4,5-dihydroxyethylene urea, or mixtures thereof.

23. The method of claim 1 wherein degradable or reversible superabsorbent polymer comprises a polysaccharide.

24. The method of claim 1 wherein degradable or reversible superabsorbent polymer comprises a protein.

25. The method of claim 13 wherein the reversing or degrading agent is an enzyme.
